(19) United States
(12) Patent Application Publication
(10) Pub. No.: US 2005/0014082 A1
(43) Pub. Date: Jan. 20, 2005

(54) Toner for electrophotography, and developing agent, image formation device and image formation method using the same

(76) Inventors: Seijiro Ishimaru, Kanagawa (JP); Sadaaki Yoshida, Kanagawa (JP)

Correspondence Address: OLIFF & BERRIDGE, PLC, P.O. BOX 19928, ALEXANDRIA, VA, 22320, US

(21) Appl. No.: 10/493,790

(22) PCT Filed: Jun. 7, 2002
(86) PCT No.: PCT/JP02/05668

(51) Int. Cl. G03G 9/09

(52) U.S. Cl. 430/108.6

(57) ABSTRACT

An object of the present invention is to provide an electrophotographic toner which has good fabrication property and excellent developing property, and can form an image having sufficient density and excellent fixing property. As a coloring material for the electrophotographic toner, a black pigment with substantially weak magnetic or non-magnetic property and having a predetermined particle size is used. The electrophotographic toner comprises: a binder resin; and particles containing manganese and iron and having a hematite structure, wherein manganese content is 3 to 30% by weight, an average particle size is 0.01 to 2.0 μm, and saturation magnetization (σs) is 2 emu/g or less, in the particles.

### BACKGROUND OF THE INVENTION

1. Field of the Invention

The present invention relates to an electrophotographic toner for visualizing an electrostatic latent image formed on a surface of a photoconductive insulator such as a photoconductive drum in an electrophotographic method or the like, an electrophotographic developer using the same, an image forming device and an image forming method.

2. Description of the Related Art

Conventionally, there has been an electrophotographic method as one of methods to visualize electric image data on a recording paper or the like. In the electrophotographic method, an electrostatic latent image is firstly formed on a surface of a photoconductive insulator (a photoconductive drum or the like). Then, a monocomponent toner which is charged by a developing unit equipped with a contact charging mechanism such as a blade, and a two-component toner which is charged by being brought into contact with carriers, are electrically adhered to the electrostatic latent image, and the latent image is visualized by development to obtain a toner image. Further, the toner image is transferred onto a recording paper or the like, and the toner is melted and solidified to obtain a printed article.

The formation of the toner image on the surface of the photoconductive insulator is carried out, for example, by providing uniform electrostatic charge on the surface of the photoconductive insulator (a photoconductive drum or the like) by corona discharge or the like, forming an electrostatic latent image by irradiating an optical image on the photoconductive insulator by suitable means, and then adhering the toner which has been charged by the electric absorption force of the electrostatic latent image.

As the toner for developing and visualizing the electrostatic latent image, there are used particles that are obtained by finely pulverizing a substance obtained by dispersing a colorant, and if necessary, an additive, such as a charge controlling agent, into a binder resin comprising a natural or synthetic polymer substance or the like, to approximately 1 to 30 μm.

The fixing method of the toner image transferred onto the recording paper or the like includes a method of melting the toner by a method of pressuring, heating or a combination thereof, and then solidifying and fixing it, a method of melting the toner by irradiating photon energy, and then solidifying and fixing it, and the like. The toner fixed on the recording paper forms a semi-eternal image, and is used as indispensable visualized information in recent society. Selection of a colorant used for the toner at visualization is very important as it greatly affects image quality.

Recently, there have been various kinds of electrophotographic images, ranging from monochrome images and mono-color images to full-color images. Among these, permeation of full-color images has been remarkable. However, since it is common for a full-color device forming the full-color image to form an image by arranging 4 colors—that is, black, in addition to yellow, magenta and cyan, the market for monochrome images is very large, and black pigment is an indispensable material for electrophotography. After the black pigment is mixed, kneaded and dispersed with a resin, they are pulverized and classified to be arranged into a desired particle size, inorganic particles or organic particles are treated by external additives, if necessary, such as imparting of fluidity, imparting of charge property, and adjustment of resistance to be used as a toner. As the black pigment, carbon black particle powder as a non-magnetic toner, magnetite powder particles as a magnetic toner, or the like have been widely used.

However, there has been a problem in that the carbon black particle powder, being ultra fine particles, must be very carefully treated during production of the toner from the viewpoint of safety and sanitation. Further, since it is bulky powder, there has been a problem in that handling property and fabrication property are bad. Furthermore, although carbon black has very high masking rate and is a material having a high degree of blackness, viscosity increases in accordance with the added amount due to a filler effect, and therefore there has been a problem in that fixing property is lowered.

As for the magnetite powder particles, there have been problems in that coagulation force between particles is strong, dispersibility is bad, and fabrication property and stability of resistance when formed into a toner and charge property are bad, and the like. When the magnetite powder particles are used under a high temperature condition in the production process of the toner and the fixing process in a printer or the like, the color changes from black to brown, and therefore there has been a problem in usage as a black colorant. Hematite powder particles are mentioned as a weak magnetic material or non-magnetic material having good handling property. However, there have been problems in that they have a low degree of blackness and it is difficult to obtain sufficient image density.

### SUMMARY OF THE INVENTION

An object of the present invention is to provide an electrophotographic toner which has good fabrication property and excellent developing property, and can form an image having a sufficient density and excellent fixing property by using a black pigment with substantially weak magnetic or non-magnetic property and having a predetermined particle size as a coloring material for a toner; an electrophotographic developer using the same; an image forming device and an image forming method.

The electrophotographic toner of the invention for achieving the object of the invention comprises: a binder resin; and particles containing manganese and iron and having a hematite structure, wherein the manganese content is 3 to 30% by weight, an average particle size is 0.01 to 2.0 μm, and saturation magnetization (σs) is 2 emu/g or less, in the particles. The electrophotographic developer of the invention for achieving the object of the invention comprises at least the electrophotographic toner of the invention. The electrophotographic image forming device of the invention for achieving the object of the invention has at least an electrostatic latent image holding member, an electrostatic latent image forming means which forms an electrostatic latent image on the electrostatic latent image holding member, a developing means which stores the electrophotographic developer of the invention and develops the electrostatic latent image to form a visible image, and a transfer means which transfers the visible image onto a transfer material.

### DETAILED DESCRIPTION OF THE PREFERRED EMBODIMENTS

[Electrophotographic Toner]

The electrophotographic toner of the present invention contains predetermined particles and a binder resin, and other components, if necessary.

Particles

The particles contain manganese and iron, and have a hematite structure. The manganese content is 3 to 30% by weight, the average particle size is 0.01 to 2.0 μm, and saturation magnetization (as) is 2 emu/g or less, in the particles.

In the particles, the manganese content is preferably 10 to 30% by weight and more preferably 20 to 25% by weight.

When the content is less than 3% by weight, the degree of blackness in the electrophotographic toner is lowered, and on the other hand, when it exceeds 30% by weight, it is not preferable because the degree of brownness becomes stronger.

In the particles, the average particle size is preferably 0.05 to 1.0 μm and more preferably 0.1 to 0.8 μm.

When the average particle size exceeds 2 μm, the dispersion diameter becomes large when making a toner, and sufficient degree of blackness cannot be obtained. On the other hand, the smaller the average particle size, the better it is. However, for the average particle size to be less than 0.01 μm, cracking process and classification process are required, which makes the cost very high. Accordingly, in some cases, it is not practical to use it as a colorant for the toner. Therefore, it is preferably 0.01 μm or more in practical use.

In the invention, the average particle size is determined by calculating an average radius from the area of one particle for particles that are observed by an electron microscope (SEM) using image analysis equipment and determining the particle size, and 10 or more of n number are counted by similar work to be determined as an average value.

In the particles, it is preferable that the saturation magnetization (as) has substantially weak magnetism or non-magnetism property. Specifically, it is preferably 1.5 emu/g or less, and more preferably 1 emu/g or less.

In the invention, “saturation magnetization (as)” is a value measured at a magnetic field of 10 KOe in powder condition.

<<Preparation Method of Particles>>

The preparation method of the particles is not specifically limited, but the method described below is specifically preferred. For example, Mn or Mn and iron are added to a suspension containing magnetite particles, in a state of an aqueous solution. The suspension is oxidized by heating, and exists in a state in which an Mn compound or an Mn compound and an Fe compound are homogeneously mixed, or a condition in which the surface of the magnetite particles is coated by existence of an Mn compound or an Mn compound and an Fe compound.

By washing mixture particles of the Mn compound-Fe compound-magnetite or the like in the suspension with water, drying, and calcining them at a temperature range of 600° C. to 1100° C., black particles with substantially weak magnetism or non-magnetism property having a hematite structure in which the saturation magnetization (σs) is 2.0 emu/g or less, Mn is a solid solution, and iron is a main component, can be obtained efficiently.

In the invention, the temperature of calcination by heating when preparing the particles is preferably the above-mentioned temperature range, namely 600 to 1100° C. and more preferably 700° to 1000° C.

When the temperature of calcination by heating is less than 600° C., the magnetite particles are hardly changed to the hematite structure, and magnetism is easily maintained. On the other hand, when it exceeds 1100° C., in some cases, the desired particle size cannot be obtained due to coagulation of particles.

<<Content of Particles>>

The content of the particles in the electrophotographic toner of the invention is not specifically limited. However, it is preferably 10 to 70% by weight, more preferably 15 to 50% by weight and further preferably 20 to 40% by weight.

When the content is less than 10% by weight, in some cases, sufficient degree of blackness cannot be obtained. On the other hand, when it exceeds 70% by weight, in some cases, fixing property is lowered.

Binder Resin

The binder resin is not specifically limited, and there are various known thermoplastic resins comprising a natural or synthetic polymer. A preferable example includes a resin having a weight average molecular weight of approximately 4000 to 100000 and a melting point of approximately 90 to 150° C., or the like. Specific examples of the binder resin include an epoxy resin, a styrene-acryl resin, a polyether-polyol resin, a polyethylene, a cycloolefin resin such as a polypropylene, a polyacryl resin, a polyamide resin, a polyester resin, a polyvinyl resin, a polyurethane resin, a polybutadiene resin or the like. These may be used alone, or two or more may be used in combination. Among these, a polyester resin or the like are particularly preferable.

The content of the binder resin in the electrophotographic toner of the invention is not specifically limited; however, it is preferably 30 to 95% by weight and more preferably 40 to 90% by weight.

Other Components

Other components are not specifically limited and can be selected suitably among known articles according to the purpose. Examples include a colorant other than the predetermined particles, an infrared absorbing agent, a charge controlling agent, a fluidity improving agent, waxes, a fixation aid, a metal soap, a cleaning activator, a surfactant or the like.

Colorant

Further desired coloring property can be realized by mixing various known colorants for respective colors such as yellow, magenta, cyan and black in the electrophotographic toner of the invention, other than the above-mentioned predetermined particles containing the manganese and iron and having the hematite structure.

The colorant is not specifically limited and can be selected suitably among known articles according to the purpose. Examples of the colorant include a yellow colorant, a magenta colorant, a cyan colorant, a black colorant or the like. Specific examples include lamp black, iron black, navy blue, a nigrosin dye, aniline blue, Calco Oil Blue, Du Pont Oil Red, quinoline yellow, methylene blue chloride, phthalocyanine blue, phthalocyanine green, Hanza Yellow, Rhodamine 6C lake, chrome yellow, quinacridone, benzidine yellow, malachite green, malachite green hexalate, rose bengal, naphthol, carmine, quinacridone, a mono-azo dye and pigment, a dis-azo dye and pigment, a tris-azo dye pigment, and the like.

Examples of the yellow colorant include a condensed azo compound, an isoindolinone compound, an anthraquinone compound, an azo metal complex, a methine compound, an arylamide compound, and the like. Specific preferable examples, include C.I. Pigment Yellows 12, 13, 14, 15, 17, 62, 74, 83, 93, 94, 95, 109, 110, 111, 128, 129, 147, 168, 180, 185, or the like.

Examples of the magenta colorant include a condensed azo compound, a diketopyrrolopyrole compound, anthraquinone, a quinacridone compound, a base dye lake compound, a naphthol compound, a benzimidazol compound, a thioindigo compound, a perylene compound or the like. Specifically, preferably they include C.I. Pigment Reds 2, 3, 5, 6, 7, 23, 48:2, 48:3, 48:4, 57:1, 81:1, 122, 144, 146, 166, 169, 177, 184, 185, 202, 206, 220, 221, 254 or the like.

Examples of the cyan colorant include a copper phthalocyanine compound and its derivative, an anthraquinone compound, abase dye lake compound or the like. Specifically, preferably they include C.I. Pigment Blues 1, 7, 15, 15:1, 15:2, 15:3, 15:4, 60, 62, 66 or the like.

These colorants may be used alone, or two or more may be used in combination.

The content of the colorant in the electrophotographic toner of the invention is preferably 0.1 to 20% by weight and more preferably 0.2 to 10% by weight.

Infrared Absorbing Agent

The infrared absorbing agent may be a material having at least one or more of intense optical absorption peaks at near infrared region of 750 to 1200 nm, and may be either of an inorganic infrared absorbing agent or an organic infrared absorbing agent.

Examples of the inorganic infrared absorbing agent include lanthanoid compounds such as ytterbium oxide and ytterbium phosphate, indium tin oxide, stannic oxide or the like.

Examples of the organic infrared absorbing agent include an aminium compound, a diimmonium compound, a naphthalocyanine compound, a cyanine compound, a polymethine compound or the like.

These colorants may be used alone, or two or more may be used in combination.

The content of the infrared absorbing agent in the electrophotographic toner of the invention is preferably 0.1 to 5% by weight and more preferably 0.3 to 3% by weight.

When the content is less than 0.1% by weight, the electrophotographic toner may not be able to be fixed, and on the other hand, when it exceeds 5% by weight, the color of an image formed may be turbid.

Charge Controlling Agent

The charge quantity of the electrophotographic toner of the invention can be easily controlled within a desired range by using the charge controlling agent. As the charge controlling agent, a positive polar charge controlling agent, a negative polar charge controlling agent or the like are used suitably by applying a positive charge or a negative charge to the binder resin. Examples of the positive polar charge controlling agent include a nigrosin dye, a quaternary ammonium salt, a triphenyl methane derivative or the like. Examples of the negative polar charge controlling agent include a metal-containing azo complex, a zinc naphthoate complex, a zinc salicylate complex, a calixarene compound or the like. These may be used alone, or two or more may be used in combination.

Fluidity Improving Agent

The fluidity improving agent is not specifically limited and can be selected suitably among known articles according to the purose. Examples of the fluidity improving agent include inorganic fine particles such as white particles or the like.

The primary average particle size of the inorganic fine particles is preferably 5 nm to 2 μm and more preferably 5 nm to 500 nm. The specific surface area of the inorganic fine particles by a BET method is preferably 20 to 500 m²/g. Examples of the inorganic fine particle include silica fine powder, alumina, titanium oxide, barium titanate, magnesium titanate, calcium titanate, strontium titanate, zinc oxide, silica, clay, mica, wollastonite, diatom earth, chromium oxide, cerium oxide, iron oxide red, antimony trioxide, magnesium oxide, zirconium oxide, barium sulfate, barium carbonate, calcium carbonate, silicon carbide, silicon nitride or the like.

These may be used alone, or two or more may be used in combination. Among these, silica fine powder is preferable, and a combination of silica fine powder, a titanium compound, resin fine powder and alumina or the like is also preferable.

The content of the fluidity improving agent in the electrophotographic toner of the invention is preferably 0.01 to 5% by weight and more preferably 0.01 to 2.0% by weight.

Cleaning Activator

The cleaning activator is not specifically limited and can be suitably selected among known articles according to the purpose. Examples of the cleaning activator include a metal salt of higher fatty acid which is represented by zinc stearate or the like, the fine particle powder of a fluorine-base polymer or the like.

Surfactant

An example of the surfactant includes a nonionic surfactant or the like.

<Production Method of Electrophotographic Toner>

The production method of the electrophotographic toner of the invention is not specifically limited and can be suitably selected among known methods according to the purpose. An example of the production method includes a mechanically pulverizing method of producing the predetermined particles by homogeneously mixing together with toner raw materials such as a binder resin, a wax component, a colorant (pigment or the like) other than the predetermined particles and various additives (an infrared absorbing agent, a charge controlling agent, a magnetic body or the like) by using a mixing apparatus such as a ball mill and a Henschel mixer, then melting and kneading by using a heat kneading apparatus such as a heating roll, a pressuring kneader and an extruder, dispersing in a resin a metal compound, a pigment, a dye, a magnetic body or the like to solidify them by cooling, then pulverizing them using a pulverizing apparatus such as a jet mill, and classifying the pulverized articles to a desired particle size distribution by a wind power classification device or the like, and the like. Further, the predetermined particles can be obtained by adjusting fluidity and charge property by carrying out surface treatment of silica fine powder or the like, if necessary.

<Magnetism of Electrophotographic Toner>

The electrophotographic toner of the invention differs from a magnetic toner which is adsorbed on a developer holding member by magnetic retention force. Specifically, as the magnetism of the electrophotographic toner of the invention, it is preferable that the saturation magnetization (as) has substantially weak magnetic or non-magnetic property which is 2 emu/g or less, 0.5 emu/g or less is more preferable and 0.1 emu/g or less is further preferable.

[Developer for Electrophotographic Toner]

The electrophotographic developer of the invention contains at least the electrophotographic toner of the invention, and contains other components which are selected suitably, if necessary.

The electrophotographic developer may be a non-magnetic monocomponent developer comprising the electrophotographic toner, and may be a two-component developer containing the electrophotographic toner and a carrier. However, when it is used for a high-speed printer or the like corresponding to the recent improvement in information processing speed, the two-component developer is preferable from the viewpoint of longer operational life or the like.

Carrier

The carrier is not specifically limited and can be selected suitably according to the purpose. However, those having a core and a resin layer coating the core are preferable.

As a material for the core, for example, a manganese-strontium (Mn—Sr)-base material, a manganese-magnesium (Mn—Mg)-base material or the like, being 50 to 90 emu/g are preferable. From the viewpoint of securing image density, low-resistance materials such as iron powder (100 emu/g or more) and magnetite (75 to 120 emu/g) are preferable. From the viewpoint that hit to a photoreceptor being in a state in which the toner is eared can be weakened which is advantageous in enhancing image quality, weak magnetic materials such as copper-zinc (Cu—Zn)-base (30 to 80 emu/g) are preferable. These may be used alone, or two or more may be used in combination.

The particle size of the core is preferably an average particle size of 10 to 150 μm, and 40 to 100 μm is more preferable.

When the average particle size is less than 10 μm, an amount of fine powder increases in the distribution of carrier particles, and magnetization per particle decreases, which may cause carrier scattering in some cases. When it exceeds 150 μm, specific surface area decreases, and scattering of a toner may occur, and in particular, reproduction of a solid portion may deteriorate in some cases. The average particle size is a value determined by the same measurement method of an average particle size mentioned above.

The material of the resin layer is not specifically limited and can be selected suitably among known materials according to the purpose. However, from the viewpoint of durability, long life or the like, preferable examples of the material of the resin layer include silicone resins such as a silicone-base resin, an acryl-modified silicone-base resin, and a fluorine-modified silicone-base resin. These may be used alone, or two or more may be used in combination.

The resin layer can be formed, for example, by dissolving the silicone resin or the like in a solvent to prepare a coating solution, then uniformly coating the coating solution on the surface of the core by known methods such as an immersion method, a spray method, and a brush coating method, drying it, and then carrying out baking, and the like.

The solvent is not specifically limited and can be selected suitably according to the purpose. However, examples of the solvent include toluene, xylene, methyl ethyl ketone, methyl isobutyl ketone, cellosolve butyl acetate or the like.

The baking may be an external heating system, or may be an internal heating system. Examples include a method using a fixed electric furnace, a fluidized electric furnace, a rotary electric furnace, a burner furnace or the like, a method using microwave, and the like.

The ratio (the coating amount of a resin) in the carrier of the resin layer is preferably 0.01 to 5.0% by weight based on the total amount of the carrier.

When the ratio (the coating amount of a resin) is less than 0.01% by weight, a uniform resin layer cannot be formed on the surface of the core in some cases. When it exceeds 5.0% by weight, the resin layer becomes too thick, granulation of mutual carriers is generated, and uniform carrier particles cannot be obtained in some cases.

When the electrophotographic developer is the two-component developer, the content of the carrier in the two-component developer is not specifically limited and can be selected suitably according to the purpose. However, for example, 90 to 98% by weight is preferable, and 93 to 97% by weight is more preferable.

Since the electrophotographic developer of the invention contains the electrophotographic toner of the invention, fabrication property is good and an image with sufficient density can be formed. The electrophotographic developer of the invention can be used suitably to form an image by known various electrophotographic methods such as a non-magnetic monocomponent developing method and a two-component developing method, and in particular, can be used suitably for the image forming method and the image forming device of the invention to be discussed hereinafter.

[Image Forming Method and Image Forming Device]

The image forming method of the invention includes at least an electrostatic latent image forming step, a developing step, and a transfer step, and preferably further includes a fixing step, and may include other steps which are selected suitably, if necessary, such as an electricity removal step, a cleaning step, a recycling step, and a controlling step.

The image forming device of the invention has at least an electrostatic latent image holding member, an electrostatic latent image forming means, a developing means, and a transfer means, and further preferably has a fixing means, and may have other means which are selected suitably, if necessary, such as an electricity removal means, a cleaning means, a recycling means, and a controlling means.

The image forming method of the invention can be carried out suitably by the image forming device of the invention, the electrostatic latent image forming step can be preferably carried out by the electrostatic latent image forming means, the developing step can be carried out by the developing means, the transfer step can be carried out by the transfer means, the fixing step can be carried out by the fixing means, and the other steps can be carried out by the other means.

Electrostatic Latent Image Forming Step and Electrostatic Latent Image Forming Means

The electrostatic latent image forming step is a step of forming an electrostatic latent image on a electrostatic latent image holding member.

As the electrostatic latent image holding member (occasionally referred to as “photoconductive insulator” and “photoreceptor”), the material, shape, structure, size, or the like thereof are not specifically limited, and may be selected suitably among known articles. However, preferable shape is a drum shape. Examples of the material include inorganic photoreceptors bodies such as amorphous silicon and selenium, organic photoreceptors such as a polysilane and phthalocyanine, or the like.

The formation of the electrostatic latent image can be carried out by, for example, uniformly charging the surface of the electrostatic latent image holding member and then exposing it imagewise, and can be carried out by the electrostatic latent image forming means.

The electrostatic latent image forming means is provided with at least a charge device which uniformly charges the surface of the electrostatic latent image holding member, and an exposure device which imagewise exposes the surface of the electrostatic latent image holding member.

The charge can be carried out by, for example, applying a voltage on the surface of the electrostatic latent image holding member using the charge device.

The charge device is not specifically limited and can be selected suitably according to the purpose. However, examples of the charge device include a known contact type charge device equipped with a conductive or semiconductive roll, brush, film, rubber blade or the like, a non-contact type charge device utilizing corona discharge such as a corotron and a scorotron, and the like.

The exposure can be carried out by, for example, exposing the surface of the electrostatic latent image holding member imagewise by using the exposure device.

The charge device is not specifically limited as long as it can imagewise expose the surface of the charged electrostatic latent image holding member by using the charge device, and can be selected suitably according to the purpose. Examples of the exposure device include various exposure devices such as a copy optics, a rod lens array system, a LED system, a laser optics system, and a liquid crystal shutter optics system.

Further, in the invention, an optical rear system which carries out exposure imagewise from the rear side of the electrostatic latent image holding member may be used.

Developing Step and Developing Means

The developing step is a step of developing the electrostatic latent image using the electrophotographic developer, and forming a visible image.

The formation of the visible image can be carried out by, for example, developing the electrostatic latent image using the electrophotographic developer, and can be carried out by the developing means.

The developing means stores the electrophotographic developer, and has at least a developing unit which imparts the electrophotographic developer to the electrostatic latent image in contact or in non-contact.

The developing unit may be a dry developing system, may be a mono color developing unit, or may be a multi-color developing unit. However, preferable examples of the developing unit include those having a stirrer which stirs the electrophotographic developer by friction to be charged, and a magnet roller capable of rotating, and the like.

For example, in the developing unit, the electrophotographic toner and the carrier are stirred by mixing, the electrophotographic toner is charged by the friction at that time and kept on the surface of the rotating magnet roller in an earring state, and a magnet brush is formed. Since the magnet roller is arranged near the electrostatic latent image holding member (photoreceptor), a portion of the electrophotographic toner which composes the magnet brush formed on the surface of the magnet roller is moved to the surface of the electrostatic latent image holding member (photoreceptor) by electric absorbing force. As a result, the electrostatic latent image is developed by the electrophotographic toner, and a visible image by the toner is formed on the surface of the electrostatic latent image holding member (photoreceptor).

While the developer stored in the developing unit is the electrophotographic developer of the invention, the electrophotographic developer may be a monocomponent developer or a two-component developer. The toner contained in the electrophotographic developer is the electrophotographic toner of the invention. A black toner is generally used in the case of development for mono color, and a chromatic color toner selected from a magenta toner, a yellow toner, and a cyan toner is used in addition to the black toner in the case of development for multi-colors. In the case of full colors, a black toner, a magenta toner, a yellow toner, and a cyan toner are used.

Transfer Step and Transfer Means

The transfer step is a step of transferring the visible image to a transfer material.

The transfer can be carried out by, for example, using a transfer charge device which is reverse polar against the electrophotographic toner, for the visible image, and by a transfer means.

The transfer means has at least a transfer device which peals and charges the visible image formed on the electrostatic latent image holding member (photoreceptor), to the transfer material.

Examples of the transfer device include a corona transfer device by corona discharge, a transfer belt, a transfer roller, a pressuring transfer roller, an adhesive transfer device or the like.

The transfer material is not specifically limited, and can be selected suitably among known recording media (a recording paper).

Fixing Step and Fixing Means

The fixing step is a step of fixing the transfer image transferred onto the transfer material using the fixation device.

The fixation may be, for example, fixation by heating and pressuring the transfer image transferred onto the transfer material, using a heating fixation roller. However, optical fixation is preferable, and can be carried out by the fixing means.

The optical fixation can be performed, for example, by carrying out optical irradiation against the transfer image transferred onto the transfer material, using an optical fixation device, and can be carried out by the optical fixing means.

As the optical fixing means, a flash lamp irradiating infrared rays is preferable.

The flash lamp is not specifically limited, and can be selected suitably according to the purpose. Preferable examples include an infrared lamp, a xenon lamp or the like.

Flash energy in the optical fixation is preferably approximately 1 to 3 J/cm².

When the flash energy is less than 1 J/cm², fixation cannot be carried out well in some cases. On the other hand, when it exceeds 3 J/cm², toner void, scorching of papers or the like may occur.

The electricity removal step is a step of removing electricity by carrying out whole surface exposure or by applying electricity removal bias to the electrostatic latent image holding member, and can be carried out suitably by the electricity removal means.

The electricity removal means is not specifically limited as long as it can carry out exposure or apply electricity removal bias to the electrostatic latent image holding member, and can be selected suitably among known electricity removal devices.

The cleaning step is a step of removing the electrophotographic toner remaining on the electrostatic latent image holding member, and can be carried out suitably by the cleaning means.

The cleaning means is not specifically limited as long as it can remove the electrophotographic toner remaining on the electrostatic latent image holding member, and can be selected suitably among known cleaners. Preferable examples of the cleaner include a magnetic brush cleaner, an electrostatic brush cleaner, a magnetic roller cleaner, a blade cleaner, a brush cleaner, web cleaner, or the like.

The recycling step is a step of recycling the electrophotographic toner which is removed by the cleaning step, into the developing means, and can be carried out suitably by the recycling means.

The recycling means is not specifically limited, and may be known conveying means or the like.

The controlling means is not specifically limited as long as it can control the motion of the respective means, and can be selected suitably according to the purpose. Examples of the controlling means include equipment such as a sequencer and a computer.

In the image forming method of the invention, an electrostatic latent image is formed on the electrostatic latent image holding member in the electrostatic latent image forming step. The electrostatic latent image is developed by the electrophotographic developer in the developing step to form a visible image. In the transfer step, the visible image is transferred onto the transfer material. In the fixing step, the transfer image transferred is fixed onto the transfer material. As a result, an image is formed on the transfer material. As a result, an image is fixed and formed at extremely high speed on the transfer material.

Further, in the image forming device of the invention, the electrostatic latent image forming means forms the electrostatic latent image on the electrostatic latent image holding member. The developing means stores the electrophotographic developer, develops the electrostatic latent image, and forms the visible image. The transfer means transfers the visible image onto the transfer material. The fixing means fixes the transfer image transferred onto the transfer material. As a result, an image is fixed and formed at extremely high speed on the transfer material.

Since the electrophotographic developer of the invention containing the electrophotographic toner of the invention is used as the electrophotographic developer in the image forming device and image forming method, an image excellent in image quality and chroma can be formed efficiently.

Although the image forming device is not specifically limited, it is preferably a high speed developing type in which processing speed is approximately 1100 mm/s, and is preferably a device having a photoreceptor comprising amorphous silicon.

### EXAMPLES

Hereinafter, the present invention will be described in further detail with reference to Examples. However, the invention is not limited to these Examples at all.

### Examples 1 to 12, Comparative Examples 1 to 7

Preparation of Black Particles (Pigments 1 to 10)

Mixture particles of an Mn compound-an Fe compound-magnetite are washed with water, dried and calcined by heating at a high temperature of 850° C. to prepare the respective black particles (pigments 1 to 10) shown in Table 1. The calcination temperatures when calcining the respective black particles by heating, Mn contents (% by weight) in the respective black particles, particle size (average particle size (μm)), and saturation magnetization (as (emu/g)) measured at a magnetic field of 10 KOe in powder state are respectively shown in Table 1. Further, the details of other pigments (a magnetite pigment, a hematite pigment, a carbon black pigment, a cyan pigment, a yellow pigment, and a magenta pigment) are similarly shown in Table 1.

TABLE 1

| | | Pigment | Pigment | Pigment | Pigment | Pigment | Pigment | Pigment | Pigment | Pigment | Pigment |
|---|---|---|---|---|---|---|---|---|---|---|---|
| Material | | 1 | 2 | 3 | 4 | 5 | 6 | 7 | 8 | 9 | 10 |
| Mn content | wet % | 22 | 3 | 30 | 1 | 40 | 22 | 22 | 22 | 22 | 22 |
| Particle size | μm | 0.3 | 0.3 | 0.3 | 0.3 | 0.3 | 0.01 | 2.0 | 4.0 | 0.3 | 0.3 |
| σs | emu/g | 0.6 | 0.6 | 0.6 | 0.6 | 0.6 | 0.6 | 0.6 | 0.6 | 2 | 5 |
| Calcination | ° C. | 850 | 850 | 850 | 850 | 850 | 850 | 1100 | 1200 | 600 | 300 |
| temperature | | | | | | | | | | | |

| | | Magnetite | Hematite | | | Yellow | Magenta | |
|---|---|---|---|---|---|---|---|---|
| Material | | pigment | pigment | Carbon black | Cyan pigment | pigment | pigment | — |
| Mn content | wet % | 0 | 0 | — | — | — | — | — |
| Particle size | μm | 0.3 | 0.3 | Primary particle | — | — | — | — |
| | | | | size 25 nm | | | | |
| σs | emu/g | 50 | 2 | — | — | — | — | — |
| Calcination | ° C. | — | — | — | — | — | — | — |
| temperature | | | | | | | | |

Preparation of Electrophotographic Toner

The electrophotographic toners 1 to 19 shown in Table 2 are prepared by the compounding amount of components shown in Table 2.

In the preparation, a polyester resin (manufactured by Kao Corporation) is used as a binder resin, N-01 (trade name, manufactured by Orient Chemical Industries, Ltd.) is used as a positive polar charge controlling agent, and polypropylene-base wax NP105 (trade name, manufactured by Mitsui Chemicals Inc.) is used as wax. After the respective components are charged in a Henschel mixer to carry out preliminary mixing, the respective components are melt-kneaded to be dispersed and solidified in a binder resin. They are pulverized and classified to obtain a positive charge black toner mother body having an average particle size of 9 μm. To the toner mother body obtained, 0.8 parts by weight of hydrophobic silica is externally added to obtain the respective electrophotographic toners 1 to 19.

A polyester resin in which the ethylene oxide of bisphenol A is a main diol component and terephthalic acid and trimellitic acid are main carboxylic acid components is used.

Preparation of Electrophotographic Developers 1 to 19

The electrophotographic toners 1 to 19 are respectively compounded with ferrite carrier (an average particle size of 70 μm) at a toner concentration of 4.5% by weight to obtain the electrophotographic developers 1 to 19 shown in Table 2. The electrophotographic developers 1 to 3 obtained are respectively used as the electrophotographic developers of Examples 1 to 3, the electrophotographic developers 4 to 5 are respectively used as the electrophotographic developers of Comparative Examples 1 to 2, the electrophotographic developers 6 to 7 are respectively used as the electrophotographic developers of Examples 4 to 5, the electrophotographic developer 8 is used as the electrophotographic developer of Comparative Example 3, the electrophotographic developer 9 is used as the electrophotographic developer of Example 6, the electrophotographic developers 10 to 13 are respectively used as the electrophotographic developers of Comparative Examples 4 to 7, the electrophotographic developers 14 to 19 are respectively used as the electrophotographic developers of Examples 7 to 12, and the respective evaluations shown below are carried out.

TABLE 2

| | | Electrophotographic toner | | | | | | | | | |
|---|---|---|---|---|---|---|---|---|---|---|---|
| | | Electro- | Electro- | Electro- | Electro- | Electro- | Electro- | Electro- | Electro- | Electro- | Electro- |
| | | photographic | photographic | photographic | photographic | photographic | photographic | photographic | photographic | photographic | photographic |
| | | toner 1 | toner 2 | toner 3 | toner 4 | toner 5 | toner 6 | toner 7 | toner 8 | toner 9 | toner 10 |
| Material | | (parts by mass) | (parts by mass) | (parts by mass) | (parts by mass) | (parts by mass) | (parts by mass) | (parts by mass) | (parts by mass) | (parts by mass) | (parts by mass) |
| Binder resin | Manufactured by Kao | 67 | 67 | 67 | 67 | 67 | 67 | 67 | 67 | 67 | 67 |
| (polyester resin) | Corporation | | | | | | | | | | |
| Colorant | Item 1 | Pigment 1 | Pigment 2 | Pigment 3 | Pigment 4 | Pigment 5 | Pigment 6 | Pigment 7 | Pigment 8 | Pigment 9 | Pigment 10 |
| | | 30 | 30 | 30 | 30 | 30 | 30 | 30 | 30 | 30 | 30 |
| | Item 2 | — | — | — | — | — | — | — | — | — | — |
| N-01 (charge | Manutactured by | 2 | 2 | 2 | 2 | 2 | 2 | 2 | 2 | 2 | 2 |
| controlling agent) | Orient Chemical | | | | | | | | | | |
| | Industries, Ltd. | | | | | | | | | | |
| NP105 | Manufactured by | 1 | 1 | 1 | 1 | 1 | 1 | 1 | 1 | 1 | 1 |
| (polypropylene): | Mitsui Chemicals Inc. | | | | | | | | | | |
| number average | | | | | | | | | | | |
| molecular weight | | | | | | | | | | | |
| 10000 | | | | | | | | | | | |
| Toner | σs (ems/g) | <0.1 | <0.1 | <0.1 | <0.1 | <0.1 | <0.1 | <0.1 | <0.1 | 1.1 | 3 |
| performance | Particle size (μm) | 9 | 9 | 9 | 9 | 9 | 9 | 9 | 9 | 9 | 9 |

| | | | | | | | | | | |
|---|---|---|---|---|---|---|---|---|---|---|
| Electrophotographic developer | Developer 1 | Developer 2 | Developer 3 | Developer 4 | Developer 5 | Developer 6 | Developer 7 | Developer 8 | Developer 9 | Developer 10 |
| | (Example 1) | (Example 2) | (Example 3) | (Comparative | (Comparative | (Example 4) | (Example 5) | (Comparative | (Example 6) | (Comparative |
| | | | | Example 1) | Example 2) | | | Example 3) | | Example 4) |
| Toner concentration (% by mass) | 4.5 | 4.5 | 4.5 | 4.5 | 4.5 | 4.5 | 4.5 | 4.5 | 4.5 | 4.5 |

| | | Electrophotographic toner | | | | | | | | |
|---|---|---|---|---|---|---|---|---|---|---|
| | | Electro- | Electro- | Electro- | Electro- | Electro- | Electro- | Electro- | Electro- | Electro- |
| | | photographic | photographic | photographic | photographic | photographic | photographic | photographic | photographic | photographic |
| | | toner 11 | toner 12 | toner 13 | toner 14 | toner 15 | toner 16 | toner 17 | toner 18 | toner 19 |
| Material | | (parts by mass) | (parts by mass) | (parts by mass) | (parts by mass) | (parts by mass) | (parts by mass) | (parts by mass) | (parts by mass) | (parts by mass) |
| Binder resin | Manufactured by Kao | 67 | 67 | 87 | 66 | 65.5 | 87 | 27 | 93 | 17 |
| (polyester resin) | Corporation | | | | | | | | | |
| Colorant | Item 1 | Magnetite | Hematite pigment | Carbon black | Pigment 7 | Pigment 7 | Pigment 1 | Pigment 1 | Pigment 1 | Pigment 1 |
| | | pigment, 30 | 30 | 10 | 30 | 30 | 10 | 70 | 5 | 80 |
| | Item 2 | — | — | — | Cyan 1 | Cyan, Yellow, Magenta, | — | — | — | — |
| | | — | — | — | | 0.5 wt % respectively | — | — | — | — |
| N-01 (charge | Manutactured by | 2 | 2 | 2 | 2 | 2 | 2 | 2 | 2 | 2 |
| controlling agent) | Orient Chemical | | | | | | | | | |
| | Industries, Ltd. | | | | | | | | | |
| NP105 | Manufactured by | 1 | 1 | 1 | 1 | 1 | 1 | 1 | 1 | 1 |
| (polypropylene): | Mitsui Chemicals Inc. | | | | | | | | | |
| number average | | | | | | | | | | |
| molecular weight | | | | | | | | | | |
| 10000 | | | | | | | | | | |
| Toner | σs (ems/g) | 20 | <0.1 | <0.1 | <0.1 | <0.1 | <0.1 | 0.5 | <0.1 | 0.6 |
| performance | Particle size (μm) | 9 | 9 | 9 | 9 | 9 | 9 | 9 | 9 | 9 |

| | | | | | | | | | |
|---|---|---|---|---|---|---|---|---|---|
| Electrophotographic developer | Developer 11 | Developer 12 | Developer 13 | Developer 14 | Developer 15 | Developer 16 | Developer 17 | Developer 18 | Developer 19 |
| | (Comparative | (Comparative | (Comparative | (Example 7) | (Example 8) | (Example 9) | (Example 10) | (Example 11) | (Example 12) |
| | Example 5) | Example 6) | Example 7) | | | | | | |
| Toner concentration (% by mass) | 4.5 | 4.5 | 4.5 | 4.5 | 4.5 | 4.5 | 4.5 | 4.5 | 4.5 |

In Table 2, “<0.1” indicates that saturation magnetization (σs) is less than 0.1 ems/g.

<Printing Test>

The electrophotographic developers 1 to 19 obtained are mounted on the modified machine of a printer (trade name: F6764, manufactured by Fujitsu Co., Ltd.), irradiated with xenon flash light having high luminescence intensity at a wavelength range of 700 to 1500 nm, and the toners are fixed on plain paper (trade name: “NIP-1500LT”, manufactured by Kobayashi Kirokushi Co., Ltd.) to form an image.

<<Measurement of Printing Density (OD) and Evaluation of Image Density>>

The printing density (OD) in the image obtained is measured by using Macbeth RD 918 (trade name, manufactured by Macbeth Inc.), OD when the screen attached amount of 1 inch image is 0.5 mg/cm² is measured as the printing density, and the image density is evaluated in accordance with the OD criteria described below. Results are shown in Tables 3 to 4.

OD Criteria
OD≧1.3⊚
1.3>OD≧1.2◯
1.2>OD≧1.1Δ
OD<1.1×
   <<Measurement and Evaluation of Value a and Value b>>

Value a and value b are measured for the image obtained using Spectrodensitmeter (trade name: X-Rite 938, manufactured by X-Rite Ltd.), and evaluated based on the evaluation criteria described below. Results are shown in Tables 3 to 4.

Evaluation Criteria of Value a and Value b
a≦1 and b≦1⊚
a≦3 and b≦3◯
a≦5 and b>5Δ
a>5 or b>5×
   <<Tape Pealing Test and Evaluation of Fixing Property>>

A tape pealing test shown below is carried out for the image obtained, and the toner fixation rate is evaluated according to the evaluation criteria described below.

Firstly, the image printing density on plain paper on which a toner image is fixed is measured as optical density. Then, after a pealing tape (trade name: “Scotch Mending Tape”, (manufactured by Sumitomo 3M Ltd.)) is adhered on the toner image of the plain paper, the pealing tape is pealed, and the optical density on the plain paper after pealing is measured. Taking the image printing density on plain paper before pealing as 100, the image printing density on plain paper after pealing is represented in percentage and is referred to as the toner fixation rate, by which the fixing property of the image is evaluated. Results are shown in Tables 3 to 4. The Macbeth RD 918 is used for measurement of the optical density.

Evaluation Criteria

When the image printing density is 5% or less (namely, the fixation rate is 95% or more) ⊚
When the image printing density exceeds 5% and is 10% or less (namely, the fixation rate is 90% or more and less than 95%) ◯
When the image printing density exceeds 10% and is 20% or less (namely, the fixation rate is 80% or more and less than 90%) Δ
When the image printing density exceeds 20% (namely, the fixation rate is less than 80%) ×
   <<Evaluation of Developing Property>>

Evaluation is carried out in accordance with the evaluation criteria described below by potential difference (the setting value of developing bias potential (Vb)) when the adhered amount at 1 inch screen is 0.5 mg/cm². Results are shown in Tables 3 to 4. The difference between surface potential (Vs) and the developing bias potential (Vb) is adjusted by constantly moving in parallel at 250 V.

Evaluation Criteria
300 V or less ⊚
More than 300 V, and 400 V or less ◯
More than 400 V, and 600 V or less Δ

More than 600 V ×

TABLE 3

| Example, | | | | | |
|---|---|---|---|---|---|
| Comparative | | | | | |
| Example | Example 1 | Example 2 | Example 3 | Example 4 | Example 5 |
| Electrophotographic | Electrophotographic | Electrophotographic | Electrophotographic | Electrophotographic | Electrophotographic |
| developer | developer 1 | developer 2 | developer 3 | developer 6 | developer 7 |
| Toner | 4.5 | 4.5 | 4.5 | 4.5 | 4.5 |
| concentration | | | | | |
| (% by mass) | | | | | |
| OD | ⊚ | Δ | ◯ | ⊚ | Δ |
| Fixing property | ⊚ | ⊚ | ⊚ | ⊚ | ◯ |
| (%) | | | | | |
| Property of | ⊚ | ◯ | Δ | ⊚ | Δ |
| values a and b | | | | | |
| Developing | ⊚ | ⊚ | ⊚ | ⊚ | ◯ |
| property | | | | | |
| Example, | | | | | |
| Comparative | | Comparative | Comparative | Comparative | Comparative |
| Example | Example 6 | Example 1 | Example 2 | Example 3 | Example 4 |
| Electrophotographic | Electrophotographic | Electrophotographic | Electrophotographic | Electrophotographic | Electrophotographic |
| developer | developer 9 | developer 4 | developer 5 | developer 8 | developer 10 |
| Toner | 4.5 | 4.5 | 4.5 | 4.5 | 4.5 |
| concentration | | | | | |
| (% by mass) | | | | | |
| OD | ◯ | X | Δ | X | X |
| Fixing property | ⊚ | ⊚ | ⊚ | Δ | ⊚ |
| (%) | | | | | |
| Property of | ◯ | Δ | X | Δ | Δ |
| values a and b | | | | | |
| Developing | Δ | ◯ | Δ | Δ | X |
| property | | | | | |

TABLE 4

| Example, | | | | | |
|---|---|---|---|---|---|
| Comparative | | | | | |
| Example | Example 7 | Example 8 | Example 9 | Example 10 | Example 11 |
| Electrophotographic | Fixation | Fixation | Fixation | Fixation | Fixation |
| developer | property 14 | property 15 | property 16 | property 17 | property 18 |
| Toner concentration | 4.5 | 4.5 | 4.5 | 4.5 | 4.5 |
| (% by mass) | | | | | |
| OD | ◯ | ◯ | Δ | ◯ | Δ |
| Fixing property (%) | ⊚ | ⊚ | ⊚ | Δ | ⊚ |
| Property of values | ◯ | ◯ | Δ | ⊚ | Δ |
| a and b | | | | | |
| Developing property | ⊚ | ⊚ | ⊚ | Δ | ◯ |

| Example, | | | | |
|---|---|---|---|---|
| Comparative | | Comparative | Comparative | Comparative |
| Example | Example 12 | Example 5 | Example 6 | Example 7 |
| Electrophotographic | Fixation | Fixation property | Fixation property | Fixation property |
| developer | property 19 | 11 | 12 | 13 |
| Toner concentration | 4.5 | 4.5 | 4.5 | 4.5 |
| (% by mass) | | | | |
| OD | ◯ | X | X | ⊚ |
| Fixing property (%) | Δ | ⊚ | ⊚ | X |
| Property of values | ◯ | Δ | Δ | ⊚ |
| a and b | | | | |
| Developing property | ◯ | X | ⊚ | ◯ |

According to Tables 3 and 4, the electrophotographic toners in which the predetermined amount of particles having a hematite structure in which Mn and iron are main components is compounded as a black pigment have a good degree of blackness and are superior in fabrication property. When an image is formed by the electrophotographic developer using these electrophotographic toners, it is superior in fixing property, developing property, value a and value b.

The preferable modes of the invention are additionally described as follows.

(Additional Remark 1)

An electrophotographic toner comprising: a binder resin; and particles containing manganese and iron and having a hematite structure, wherein manganese content is 3 to 30% by weight, an average particle size is 0.01 to 2.0 μm, and saturation magnetization (as) is 2 emu/g or less, in the particles.

(Additional Remark 2)

An electrophotographic toner according to Additional remark 1, wherein the particles are black powder particles obtained by calcining at least magnetite particles and a manganese compound by heating at a temperature of 600 to 1100° C.

(Additional Remark 3)

An electrophotographic toner according to Additional remark 1 or 2, wherein the manganese is manganese which is a solid solution.

(Additional Remark 4)

An electrophotographic toner according to Additional remark 2 or 3, wherein the particles have substantially weak magnetic or non-magnetic property in comparison with magnetite particles.

(Additional Remark 5)

An electrophotographic toner according to any one of Additional remarks 1 to 4, wherein the content of the particles in the electrophotographic toner is 10 to 70% by weight.

(Additional Remark 6)

An electrophotographic toner according to any one of Additional remarks 1 to 5, comprising at least any one of colorants of cyan, magenta and yellow.

(Additional Remark 7)

An electrophotographic toner according to any one of Additional remarks 1 to 6, wherein the manganese content in the particles is 10 to 30% by weight.

(Additional Remark 8)

An electrophotographic toner according to any one of Additional remarks 1 to 7, wherein an average particle size in the particles is 0.01 to 1.0 μm.

(Additional Remark 9)

An electrophotographic toner according to any one of Additional remarks 1 to 8, wherein the content of the particles in the electrophotographic toner is 15 to 50% by weight.

(Additional Remark 10)

An electrophotographic toner according to any one of Additional remarks 1 to 9, wherein saturation magnetization (σs) is 1 emu/g or less.

(Additional Remark 11)

An electrophotographic developer comprising at least the electrophotographic toner according to any one of Additional remarks 1 to 10.

(Additional Remark 12)

An electrophotographic developer according to Additional remark 11 containing a carrier.

(Additional Remark 13)

An image forming device comprising at least an electrostatic latent image holding member, an electrostatic latent image forming means which forms an electrostatic latent image on the electrostatic latent image forming holding member, a developing means which stores the electrophotographic developer according to Additional remark 11 or 12 and develops the electrostatic latent image to form a visible image, and a transfer means which transfers the visible image onto a transfer material.

(Additional Remark 14)

An image forming device according to Additional remark 13, further comprising an optical fixing means which carries out optical fixation of a transfer image transferred onto the transfer material.

(Additional Remark 15)

An image forming method comprising at least an electrostatic latent image forming step which forms an electrostatic latent image on an electrostatic latent image holding member, a developing step which develops the electrostatic latent image using the electrophotographic developer according to Additional remark 11 or 12 and forms a visible image, and a transfer step which transfers the visible image onto a transfer material.

(Additional Remark 16)

An image forming method according to Additional remark 15, further comprising a fixing step which carries out the optical fixation.

1-5. cancelled.

6. An electrophotographic toner for a photo-fixing method comprising: a binder resin; and particles containing manganese and iron and having a hematite structure, wherein manganese content is 3 to 30% by weight, an average particle size is 0.01 to 2.0 μm, and saturation magnetization (σs) is 2 emu/g or less, in the particles.

7. The electrophotographic toner for the photo-fixing method according to claim 6, wherein the particles are black powder particles obtained by calcining at least magnetite particles and a manganese compound by heating at a temperature of 600 to 1100° C.

8. The electrophotographic toner for the photo-fixing method according to claim 6, wherein the manganese is manganese which is a solid solution.

9. An electrophotographic developer containing at least the electrophotographic toner for the photo-fixing method according to claim 6.

10. An image forming device comprising at least an electrostatic latent image holding member, an electrostatic latent image forming means which forms an electrostatic latent image on the electrostatic latent image holding member, a developing means which stores the electrophotographic developer according to claim 9 and develops the electrostatic latent image to form a visible image, and a transfer means which transfers the visible image onto a transfer material.

11. The electrophotographic toner for the photo-fixing method according to claim 7, wherein the manganese is manganese which is a solid solution.

12. An electrophotographic developer containing at least the electrophotographic toner for the photo-fixing method according to claim 7.

13. An electrophotographic developer containing at least the electrophotographic toner for the photo-fixing method according to claim 8.
